(19) United States
(12) Patent Application Publication
(10) Pub. No.: US 2017/0233301 A1
(43) Pub. Date: Aug. 17, 2017

(54) METHOD, SYSTEM AND A PROCESS FOR PRODUCING FERTILIZERS FROM SEAWATER

(71) Applicants: Krishnamohan SHARMA, Milpitas, CA (US); Raghu BHAKTA, Secunderabad (IN); Tanuja Kosuri, Secunderabad (IN)

(72) Inventors: Krishnamohan SHARMA, Milpitas, CA (US); Raghu BHAKTA, Secunderabad (IN); Tanuja Kosuri, Secunderabad (IN)

(21) Appl. No.: 15/502,784

(22) PCT Filed: Jul. 10, 2015
(86) PCT No.: PCT/US15/39968

§ 371 Date: Feb. 9, 2017

(30) Foreign Application Priority Data
Aug. 11, 2014 (IN) 3932/CHE/2014

(51) Int. Cl. C05C 11/00; C05D 1/00; C05B 17/00; C05G 3/00; C01C 1/10; C01F 11/46; B01J 39/02; B01J 39/14; B01J 47/02; C02F 1/42; C02F 1/26; C02F 1/04; C02F 1/20; C02F 1/66; C02F 1/44; C02F 1/52; B01D 15/36; B01D 5/00; C22B 26/10; C05C 3/00

(52) U.S. Cl. CPC C05C 11/00; C05C 3/00; C05D 1/00; C05B 17/00; C05G 3/0076; C01C 1/10; C01F 11/46; B01J 39/02; B01J 39/14; B01J 47/02; C02F 1/42; C02F 1/26; C02F 1/04; C02F 1/20; C02F 1/66; C02F 1/441; C02F 1/5236; B01D 15/361; B01D 5/006; C22B 26/10; C01P 2006/80; C02F 2103/08

(57) ABSTRACT

The present invention relates to a process, methods and materials for generating fertilizers from seawater resources, especially in conjunction with seawater desalination plants. Here, we demonstrate that varying compositions of fertilizers such as nitrogen/potassium, nitrogen/phosphorus/potassium, nitrogen/potassium/sulfur, and nitrogen/phosphorus/potassium/sulfur, potassium/sulfur, potassium along with micro and secondary nutrients can directly be generated as part of the extraction process to meet the requirements of both starter and sustained phases of plant growth.

### CROSS REFERENCE TO RELATED APPLICATIONS

This patent application claims priority to India Provisional Application No. N-301 filed on Aug. 9, 2014, entitled “Methods, System and an Industrial Plant for Producing Liquid Fertilizer from Seawater”; the disclosure of which is incorporated by reference.

### FIELD OF USE

The present invention relates to methods, systems and processes of extracting useful fertilizer compounds from brines, especially brine reject solutions of desalination processes.

### BACKGROUND

Changes to global climate, droughts, and steady increase in human population have strained the world's fresh water reserves and the need for fresh water continues to grow. Many countries have been and will be turning to desalination to increase their supply of fresh water as demand increases. Desalinating seawater produces, as a byproduct, a brine solution full of not only concentrated salt, but also other minerals such as potassium, sulfur, magnesium, boron and calcium, which can be efficiently recovered to be used as fertilizing chemicals or plant nutrients. Besides fertilizing chemicals, the byproduct also contains lithium, bromine and uranium in enriched concentrations and may be tapped for commercial applications.

A second problem that increasing global population has to contend with is the growing need for food. As world demand for food increases, so does the demand for fertilizers. Traditionally, potassium-rich fertilizers are derived from land sources. Conventionally potassium in the form of potassium chloride is mined in the form of sylvite and halite ores, which mainly consist of KCl and NaCl. These ores are washed with hot water to remove impurities wherein concentrated KCl brine is produced. It is dried in the open ponds and crystallized. Because of this process, potassium chloride contains some sodium as impurity. According to Food and Agriculture Organization of United Nations specifications, the maximum permissible sodium chloride content is restricted to 2% by weight for various water soluble complex fertilizers, because sodium chloride causes adverse impact on uptake of water and excess sodium chloride may be detrimental to plant growth. Hence there is a need for sodium separation from potassium fertilizing compounds. This fundamental problem of sodium separation from potassium limits several of the ion exchange materials based potassium separation processes as none of the existing inorganic ionic exchange materials have exclusive selectivity towards potassium and this has been proven to be a major scientific challenge. Presently, during potassium extraction from inorganic ion exchange materials the sodium salt contamination could go up to 40% by weight depending on stripping/recovery conditions, and hence contaminated potassium salts cannot be used as fertilizing chemicals. Further, any efforts to mitigate sodium salt reduction in potassium containing product cut to below 2% using existing elution methodologies seem to result in significantly decreased potassium recovery efficiency, almost by 40-50%. Although, some crown ethers have very exclusive selectivity towards potassium, they are prohibitively expensive for commercially recovering potash from brines for fertilizing purposes. In this context, there is an urgent need for a process that generates potash fertilizers from brines with less than 2% by weight of sodium chloride contamination without compromising the potassium recovery efficiency. The present innovation successfully solves this fundamental problem with regard to generating fertilizers directly from brines.

Seawater contains large amounts of dissolved metal salts, several thousand times more abundant than on land. Some of these minerals are of high commercial interest; such as potassium, magnesium, calcium, lithium, bromine, uranium and sulfur. At present metals like potassium and lithium are commonly extracted from land-based mines because of high costs associated with developing processes for their selective isolation from seawater using existing technologies. Further, potassium mines (a major ingredient for fertilizers) are concentrated in few countries such as Canada, Russia, Belarus, and Israel, while its major importers are USA, China, India, and Brazil.

Modern RO membranes have high salt rejection capacities and are capable of producing potable water with less than 500 ppm of salinity from seawater (ca. 35,000 ppm salinity). In addition, some modern RO systems are capable of achieving up to 50 percent recovery of freshwater from seawater. Therefore, seawater RO (SWRO) plants operating at 30-50% recovery produce a brine waste (i.e., concentrated salt solution or seawater reject) stream that is about 1.4-2.0 times more concentrated than that of sea water depending upon the type of technology employed.

Indeed, the seawater reject from desalination plants is a rich source of minerals that is currently being untapped. Doubling the concentration of metal salts with low concentration such as potassium, magnesium, calcium, lithium uranium, bromine and sulfate may enable new cost effective methods of extraction, by reducing the volumes of seawater that needs to be processed, resulting in energy savings and doubling the rate of production. For example, seawater contains about 380-400 ppm of potassium and SWRO reject contains about 550-780 ppm of potassium. Therefore, extracting potassium from SWRO reject will result in cost effective production of potassium based fertilizers. By using SWRO reject as a source for mineral extraction the cost of both desalination and mineral extraction could be reduced. Further, countries like India, China, Brazil, Japan, Korea, Indonesia, Netherlands, and parts of the United States, with vast coastline, severe water scarcity, and lack of potassium resources may benefit from a technology that combines desalination plants with mineral extraction.

Currently known systems of desalination do not incorporate the added benefit of selectively extracting useful compounds singularly or in combination, to be used in fertilizer production. In addition, systems described in present patent literature do not attempt to produce multiple fertilizing quality products (with sodium levels permissible according to international standards for fertilizing chemicals), while recovering and regenerating the eluent within the same system to be reused again. Furthermore, no other known methods of mineral recovery from saltwater reject currently available, provide for ready-to-use quality liquid fertilizer components that contain acceptable levels of salt without compromising the efficiency of the recovery process. This ability to directly obtain useable liquid fertilizer components is not only cost effective, but also environmentally acceptable. Representative references include: U.S. Pat. No. 5,814,224, Chinese Patent 102826574 B, Japanese Patent 3534297, Chinese Patent 102976797, and Korean application KR20110124184.

Korean specification KR20110124184 discloses a manufacturing method of liquid fertilizer made from organic wastes. The specification discloses a method for obtaining liquid-fertilizers from organic waste without using moisture-controlling agents. The method for liquid-fertilizing organic waste includes the treatment of brine generated from surface seawater or deep seawater. The impurities are eliminated from organic waste, and the organic waste is pre-treated if the salinity of the organic waste is high. The pre-treating process is capable of being a desalinating process. The pre-treated organic waste is liquid-fertilizer based on the treated brine. In order to produce liquid-fertilized organic waste, the organic waste is fermented in an aerobic fermenting bath that is transferred to a liquid fertilizer storing bath. Precipitated solid materials are shifted or conveyed to a microorganism activating bath and a pretreated organic waste liquid storing bath. The brine is supplied into the microorganism activating bath to induce liquid fertilization.

Japanese specification JP3534297 discloses a method for the production and utilization of culture solution from seawater. The specification discloses a method for manufacturing the culture solution, the liquid fertilizer and the agricultural water from the seawater. The seawater is subjected to a Zeolite treatment and an anion exchanger resin treatment or a chitosan treatment. In the said method, the culture solution obtained from the seawater is used for aquaculture, plant tissue culture microorganism and animal cell, and the liquid fertilizer is used as a fertilizer and the agricultural water is used as irrigation water.

Chinese publication CN102976797 discloses a method for extracting potassium co-production liquid salt from concentrated seawater, and the method comprises the following steps of: taking natural Clinoptilolite as an ion exchanger, and absorbing potassium in concentrated seawater of which the elements namely bromine, magnesium, calcium and the like, are extracted, wherein the flow rate that the seawater passes into the natural Clinoptilolite is 15-20 mL/min, and the low potassium exchange fluid is a liquid salt product; taking saturated ammonium chloride solvent as a eluent solution, flowing into potassium-absorbed Zeolite at the flow rate of 10-15 mL/min, eluting and evaporating the potassium-enriched eluent to obtain an ammonium chloride potassium product. According to the method, the seawater from which the elements, namely bromine, magnesium, calcium and the like, are extracted is taken as a raw material liquid, so that, ammonium chloride containing potassium fertilizer can be obtained.

Chinese publication CN102826574 discloses a method for extracting potassium from seawater by using a continuous ion exchange method. The method comprises the following steps: that a simulation moving table is arranged by using 36 continuous ion exchange devices consisting of ion exchange columns which are provided with jackets and filled with sodium type Clinoptilolite; the simulation moving table is divided into an adsorption zone, an elution zone and a regeneration zone; the adsorption process is operated in the adsorption zone by layers and three layers are carried out in parallel; the concentration of potassium in the sea water as a raw material is 0.61-1.52 g/L; the concentration in the drained sea water after adsorption is 0.01-0.15 g/L; the elution process is operated in the elution zone by columns and three layers are carried out in series to obtain a potassium-rich solution and the concentration of K in the potassium-rich solution is 36.00-44.12 g/L; and the regeneration process is operated in the regeneration zone by columns and three layers are carried out in series to obtain ammonium-containing saltwater. The adsorption, elution and regeneration processes are simultaneously operated and thus the operation period is shortened, the efficiency is increased, the cost is reduced and economic benefits are improved.

U.S. Pat. No. 5,814,224, discloses a method for complex processing of sea-water comprises the successive steps of mechanical filtration, calcium separation on modified Zeolite, magnesium separation on weak acid cation exchanger, processing of the resulting softened seawater, regeneration of the modified Zeolite and regeneration of the weak acid cation exchanger. During the step of processing of the softened seawater, its desalination is carried out so as to produce fresh water and simultaneously secondary brine having a concentration of salts at least as high as 100 g/L whereby the modified Zeolite is regenerated. A plant for implementation of the method of complex processing of seawater comprises a filter, two sorption columns for calcium separation connected in parallel with each other, a sorption unit for magnesium separation, a softened sea-water processing unit and a mixed concentrate processing unit.

The present invention surmounts several of the technical challenges that limited the direct production of fertilizer quality compositions from brine disclosed in the prior art. The multiple innovative processes and discoveries include: i) generate fertilizer quality compositions with acceptable limits of sodium content by isolating potassium from sodium during the recovery process; ii) generate end-to-end fertilizing compositions (i.e. addressing all phases of plant growth) involving N, P, K, S with varying ratios along with micronutrients tailor made for direct usage by agricultural industry for a wide variety of crops (i.e., without further processing) as part of the metal extraction/recovery process; iii) efficiently, recover and recycle the chemicals used to make the entire process efficient and environmentally benign, and iv) integrate desalination process with fertilizer production to make them complementary to each other and make the entire process energy efficient and economical. Thus, the disclosed method does not require additional treatment steps of the reverse osmosis product prior to extracting the fertilizer-rich components, the resulting fertilizer components are ready to use without requiring additional purification steps. With the increase in world population requiring ever-increasing amounts of food, a simple, economical, and environmentally-friendly method of obtaining much-needed fertilizer components is invaluable.

### SUMMARY OF THE DISCLOSURE

The present invention discloses an integrated method, system and an industrial chemical process for the continuous production of various types of fertilizers including different concentrations of products or compositions of products or both, operable at a large industrial capacity to effectively provide high recovery and salts of enhanced purity and with enhanced efficiency. The present invention provides a novel and improved system for co-production of high purity salts, and one or more grades of high quality liquid fertilizers, such as potassium (K), or potassium (K) and sulfur (S), or potassium (K) and nitrogen (N), or potassium (K) nitrogen (N) and sulfur (S) or potassium (K), nitrogen (N) and phosphorous (P) or potassium (K), nitrogen (N), phosphor (P) and sulfur (S) or blend of such fertilizers. It also provides a simplified and cost effective process for converting seawater to liquid fertilizer.

Also disclosed is a liquid fertilizer plant that operates with sea water or brackish water feed or more specifically from SWRO reject from desalination plants and produces liquid fertilizers including a plurality of composition with components viz. phosphorous (P), potassium (K), nitrogen (N) and sulfur (S) with a plurality of concentrations and a pure water permeate stream from first treatment section that is arranged to produce primarily water with high recovery/efficiency using membrane desalination processes.

An object of the present invention is providing an innovative and cost-effective method wherein ion exchange material is made to selectively elute potassium (with unwarranted contaminations) for formulating fertilizing chemicals and may come from organic or inorganic materials. Further, the ion-exchanged material is a natural Zeolite such as Clinoptilolite or modified Zeolite or synthetic Zeolite (with defined Al/Si ratios), and/or granulated form of natural or synthetic and/or surface modified Zeolites. It is to be mentioned that only certain forms of naturally mined Clinoptilolite Zeolite compositions could be advantageously used for selective extraction of potassium owing to their higher potassium loading/stripping capacities. The potassium extracted from Zeolites is stripped using various ammonium/sodium salts, and the like.

Another object of the present invention is to provide a method wherein the affluent ammonium in seawater is recovered by combination of methods such as steam/air stripping, addition of inorganic salts of sodium and calcium comprising of NaOH, CaO, Ca(OH)₂, CaCl₂, and CaCO₃. The product cut is concentrated and/or purified by using organic solvents such as ketones, alcohols and amines (e.g., acetone, methanol or triethylamine) or by addition of aforementioned calcium salts.

Another object of the present invention is regeneration and recycling of chemicals produced during the process to make the process cost effective, green and environmental friendly, wherein the sodium rich streams generated during the process are recycled to strip ammonium ions, sodium/calcium sulfate are recycled to generate strip solutions, alkaline solutions used to remove ammonia are converted into sulfates and phosphates of calcium and/or ammonium.

Another object of the present invention is to recover the sulfate anions present in the seawater as an additional by product. The various features of novelty, which characterize the invention, are pointed out with particularity in the claims annexed to and forming a part of this disclosure. For a better understanding of the invention, its operating advantages and benefits obtained by its uses, reference is made to the accompanying drawings and descriptive matter. The accompanying drawings are intended to show examples of the few forms of the invention. The drawings are not intended as showing the limits of all of the ways the invention can be made and used. Changes to and substitutions of the various components of the invention can of course be made. The invention resides as well in sub-combinations and sub-systems of the elements described, and in methods of using them.

Described herein are methods of using seawater reject from desalination plants as a feed to produce fertilizer compositions using an ion exchange process. The desalination method is based on reverse osmosis and the fertilizer composition is in a liquid form comprising at least potassium ions, ammonium ions, phosphorous ions or a combination thereof. This method also produces a liquid fertilizer formulation having at least one primary plant nutrient in combination with at least one secondary and/or micronutrients. The liquid fertilizer formulation then can be used to produce a solid fertilizer by crystallization, evaporation, precipitation, and any other solvent and solute separation techniques thereof.

Described herein are methods of extracting compounds from a brine solution, and more specifically a desalination process. This includes loading the brine solution onto an ion exchange system to preferentially bind mono or divalent ions such as sodium ions, potassium ions, calcium ions, or magnesium ions; a second step of using an eluent with a first concentration after the first step resulting in a sodium rich salt solution; and using an eluent with a second concentration after the second step to generate a fertilizer composition comprising potassium ions along with at least phosphorus ions, ammonium ions, sulfur ions, calcium ions, magnesium ions, micronutrients or any combination thereof.

The methods described produces liquid fertilizer composition having at least one or more of the following ions: phosphorus, ammonium, potassium, sulfur, calcium ions, and magnesium, along with micronutrients and impurities having a cumulative concentration of 1-800 g/L, and in some instances having a cumulative concentration of 2-300 g/L. In other examples, concentration of N is within a range between 0-100 g/L, a concentration of P2O5 is within a range of 0-400 g/L, a concentration of K2O is within a range of 2-250 g/L, a concentration S is within a range of 0-180 g/L, a concentration of Ca is within a range of 0-20 g/L, a concentration of Mg within a range of 0-20 g/L, and the micronutrients and impurities are within a range of 0-20 g/L.

The ion exchange system has an ion exchange material, optionally at least one binder, one cross-linking agent and/or filler. The binder and/or at least one cross-linking agent comprises 4 to 20% of the ion exchange material by weight. The ion exchange material has an average particle size in the range of 100 to 2000 m, and in some instances, an average particle size in the range of 250-800 m can also be use.

In most cases, the eluent is an ammonic solution that comprises at least one ammonium salt in the form of sulfates, phosphates, carbonates, bicarbonates, carboxylates, nitrates, chlorides, or combinations thereof. In one example, the first concentration of the eluent is between 0.1 M and 3M, and the second concentration is between 0.5 M and 6 M. In other examples, the first concentration of the eluent is below 0.75M. In most instances, the second step and the third step are performed at a temperature between ambient temperature and 100° C.

The methods described also include methods directed to reclaiming the ammonic solution from the elution steps in a recovery process using eluent retained by the ion exchange system. The recovery process comprises stripping the ammonium ions from the ion exchange material using heat or steam or air or a strip solution or any combination thereof. The strip solution comprises at least one sodium-rich compound such as sodium hydroxide, sodium carbonate, sodium bicarbonate, sodium sulfate, or seawater enriched with sodium chloride, concentrated sea water or sodium chloride or a combination thereof. The strip solution has a concentration between 0.5 and 6 M or has high ionic strength wherein a total dissolved salt concentration may range from 3% by weight % to 40% by weight. The recovery process is typically performed at ambient temperature to 120° C.

Also, disclosed herein, are methods of extracting useful compounds from seawater. The steps include first obtaining seawater reject from the seawater after desalination, loading the seawater reject onto a ion exchange system to preferentially bind mono or divalent metal ions after the first step. Then using an eluent with a first concentration of an ammonic solution between 0.1M and 3M, at temperatures ranging from ambient to 100° C. to produce a sodium rich salt solution after the second step. Followed by using the eluent with a second concentration of the ammonic solution between 0.5M and 6M to generate a fertilizer composition comprising at least phosphorus ions, potassium ions, ammonium ions, calcium ions, magnesium ions, sulfur ions, or a combination thereof after the third step. And finally reclaiming the ammonium salts in a recovery process from ammonic solution retained by the ion exchange system after the fourth step. In this process, the liquid fertilizer composition can be concentrated 1.5-20 times with at least one of organic solvent extraction, thermal methods, reverse osmosis or forward osmosis after the ions of interest are obtained. The ammonium-containing eluting solution with a first concentration and a second concentration contains at least one ammonium salt in the form of sulfates, phosphates, carbonates, bicarbonates, carboxylates, nitrates, chlorides, or combinations thereof.

Similar to the first method described, the fertilizer composition comprising at least one or more of the following ions: phosphorus ions, potassium ions, sulfur ions, ammonium ions, calcium ions, and magnesium ions, along with micronutrients, and impurities having a cumulative concentration of 1-800 g/L. In some instances, the cumulative concentration is 2-300 g/L. Furthermore, the liquid fertilizer composition derived has a concentration of N within a range between 0-100 g/L, a concentration of P₂O₅ within the range of 0-400 g/L, a concentration of K₂O within the range of 2-250 g/L, a concentration S within the range of 0-180 g/L, a concentration of Ca within the range of 0-20 g/L, a concentration of Mg within the range of 0-20 g/L, and concentrations of micronutrients and impurities are within the range of 0-20 g/L.

In this case, the ion exchange system comprises an ion exchange material, optionally at least one binder, at least one cross-linking agent and/or filler. The binder and/or cross-linking agent comprises 4 to 20% of the ion exchange system by weight. The ion exchange material has an average particle size in the range of 100 to 2000 μm, and in other cases, can have a particle size between 250-800 μm.

In the ammonic recovery process, the strip solution comprising at least one sodium-rich compound, an alkaline, or an alkaline earth base. The sodium rich compound can be sodium hydroxide, sodium carbonate, sodium bicarbonate, sodium sulfate, or sodium chloride or combination thereof. The strip solution has a concentration between 0.5 and 6 M or higher ionic strength wherein a total dissolved salts concentration range from 3% by weight % to 40% by weight. The recovery process is typically performed at ambient temperature to 120° C. After recovering the ammonium-containing compounds, recycling the sodium-rich compound can also be done.

Finally described herein is the system used for obtaining fertilizer compositions from desalination rejection solution. This includes a desalination reject solution source, an ion exchange column in fluid connection with the source via a fluid connection, an ammonic reservoir with provisions for dilution in fluid connection with the ion exchange column, a sodium ion rich solution reservoir adapted to retain preferentially eluted sodium from the desalination reject solution, a product reservoir adapted to retain liquid fertilizer from the ion exchange column, an ammonia recovery chamber in fluid connection with the ammonic solution reservoir adapted to separate ammonical components from the brine solution, a product concentrator adapted to concentrate the liquid fertilizer; and an ammonical recovery system adapted to regenerate ammonic salt solution to be reused. The system also includes a second product reservoir in fluid connection with the ion exchange column adapted to collect product to make liquid fertilizers containing ions of at least phosphorus, potassium, ammonium and sulfur from the ion exchange column.

The system further includes an ammonical recovery system further comprises an ammonium reclamation system and/or an ammonia reclamation system. the ammonium reclamation system includes a reservoir adapted to store ammonium containing brine solution and to adjust the pH of the brine solution, an ammonia evolving column in fluid connection with the separator reservoir adapted to reclaim purified ammonia from ammonium containing brine, a gaseous ammonia collection reservoir in fluid connection with the ammonia evolving column, a clarifier in fluid connection with the ammonia free brine solution adapted to remove precipitated particulates from the brine solution, and a reaction vessel in fluid connection with the gaseous ammonia collection reservoir adapted to reclaim clean ammonium salts from the brine solution to be reused in the extraction system. The ammonia reclamation system includes a reaction tank in fluid connection with the gaseous eluent collection reservoir adapted to convert ammonia into ammonium salt solution, an ammonium salt slurry/solution collection reservoir in fluid connection with the reaction tank, a clarifier in fluid connection with the ammonium slurry/solution collection reservoir adapted to remove particulates, and a concentrated ammonium reservoir in fluid connection with the clarifier adapted to receive purified ammonium salt solution.

### BRIEF DESCRIPTION OF THE DRAWINGS

FIG. 1. Is a diagram of a process flow diagram of seawater based RO desalination unit. The salt concentration in seawater reject (119) is 1.4-2.0 times more than that of seawater.

FIG. 2 is a diagram of a desalination reject stream is used to selectively recover potassium and other fertilizing chemicals.

FIG. 3 is a diagram for a continuous generation of various NPKS fertilizer formulation directly off the ion exchange column.

FIG. 4 is a process flow diagram for concentrating the product cut using solvent extraction process

FIG. 5 is a process flow diagram for continuous removal of ammonia from sorbent.

FIG. 6 is a process flow diagram for recycling of ammonia.

FIG. 7 is a process flow diagram for concentrating the product cut using thermal evaporation

### DETAILED DESCRIPTION

Potassium (K) plays a vital role in the survival and growth of plant life and is very commonly supplemented as a fertilizer to satisfy the nutritional needs of plants to produce high yielding/quality crops. The demands of the growing population for food, fiber, and other commodities are rapidly expanding, while the arable land for cultivation is shrinking. Consequently, use of fertilizers such as nitrogen (N), potassium (K) and phosphorus (P) are becoming increasingly indispensable in modern agricultural system. Approximately 30 million tons/year of potassium is produced worldwide, of which 95% is used for fertilizers.

The world potassium market is characterized by a limited number of producers, supplying high concentration products to all regions. Four countries, Canada, Russia, Germany and Belarus account for three-quarters of global output, while USA, India, China and Belgium import over 60% potassium produced worldwide. Potassium is present in igneous, sedimentary, and metamorphic rocks. However, commercial recovery is mainly restricted to deeply buried marine evaporate deposits, at depths ranging from 400-1000 meters below the surface; and surface brine deposits associated with saline water bodies such as the Dead Sea.

Fertilizers are key elements for agricultural economies worldwide, including both developing and developed countries alike. The worldwide consumption of NPK fertilizers per year is currently (2015) estimated to be around 232 Million tons, which amounts to 116 Billion USD. Out of 232 million tons, K₂O amounts to 36 Million tons (14.4 Billion USD). For example, countries like India, where 65% of population depends on agriculture related activities for their livelihood import 4 million tons a year at present (1.6 Billion USD) to meet the current demands.

Indeed, seawater is a major untapped source of potassium—it comprises 100,000 tons more potassium than on land. However, the concentration of potassium in seawater is significantly low (0.4 g/L) and at present there are no cost effective technologies to extract potassium. Many of the current technologies that are aimed at extracting potassium from seawater are not only expensive but invariably contain sodium as a major impurity, rendering it unusable as a fertilizer without further processing.

Irrigation water often being saline in the cultivable areas adds to the salinity. Increased salinity increases the osmotic pressure and decreases water potential that adversely affects the water uptake by the plants. Sodium salts being highly soluble increases the soil salinity thereby affecting the plant growth. These ions can destroy soil structure and clog the flow of soil water. The commercial fertilizers should therefore be free from sodium. Therefore, one of the major objectives of this invention is to generate liquid fertilizers with acceptable sodium levels from seawater.

Liquid fertilizers are composed of water soluble compounds or liquid concentrates that are in readily soluble form in water to make a fertilizer solution. Granular forms of fertilizers take time to dissolve and absorbance of nutrients by the plants is slower. They tend to leave a residue due to inefficient uptake. On the other hand the liquid fertilizers are quickly absorbed by plants soon after their application either through roots or leaves and thereby reduce the wastage of fertilizers. Liquid fertilizer ensures even and uniform application over a given area, and if needed, water soluble pesticides can directly be introduced into liquid fertilizing formulations to simplify their application, so that nutrients are efficiently absorbed by the roots and leaves (foliar sprays) of the plants, while pesticides may fight against plant diseases. This results in healthier growth of the plants, production of high yield/quality crops with optimal consumption of fertilizers. More importantly, liquid fertilizers can be used along with drip or sprinkler irrigation systems to ensure efficient distribution of the nutrients to the plants.

Described herein are the innovative features used in the disclosed method:
The method includes the use of waste seawater from desalination plants (e.g., seawater reject from Reverse Osmosis, SWRO) to extract valuable minerals or plant nutrients namely, K, Ca, Mg and S (in the form of sulfate) in a cost effective manner. The byproducts of the process include clean/potable water, ammonium salts and sulfates/phosphates of calcium and magnesium.
The method also includes generation of high purity potassium containing product cut (for fertilizing purposes), where contamination of sodium and chloride are minimized. This objective was accomplished by using distinct concentrations of ammonium salts and water wash to selectively separate both sodium and chloride ions during the elution process.
The method also includes efficient recovery of sulfate, including the sulfate present in seawater or SWRO reject from the eluent stream in the form of CaSO₄ using CaO or Ca(OH)₂ and recycled back into the process.
The method also includes efficient recovery and recycling of sodium rich brine solutions eluted from an ion exchange column.
The method further includes zero waste and efficient recovery of more than 97% of the ammonium ions from different streams and recycles back into ammonium salt solution used for recovering potassium from Zeolites, especially Clinoptilolite type. This will lead to clean/environmentally friendly discharge of our waste streams within permissible limits.

The method includes an efficient recovery of sulfate and ammonia by combining part of the potassium loading and part of sodium stripping streams, where consumption of chemicals used is minimized and recovery of elements such as calcium and sulfate from the seawater or SWRO reject are maximized. With current process the method can produce liquid fertilizers with N/K/S, N/P/K, or N/P/K/S or N/K or K/S or K combination in different proportions along with micronutrients or secondary nutrients. The present disclosure proposes to convert seawater minerals into liquid fertilizers through a proprietary process, where the liquids (with control over pH) can contain potassium (K) and sulfur (S), or potassium (K) and nitrogen (N), or potassium (K), nitrogen (N) and sulfur (S), or potassium (K) nitrogen (N) and phosphorous (P), or potassium (K), nitrogen (N), phosphor (P) and sulfur (S).

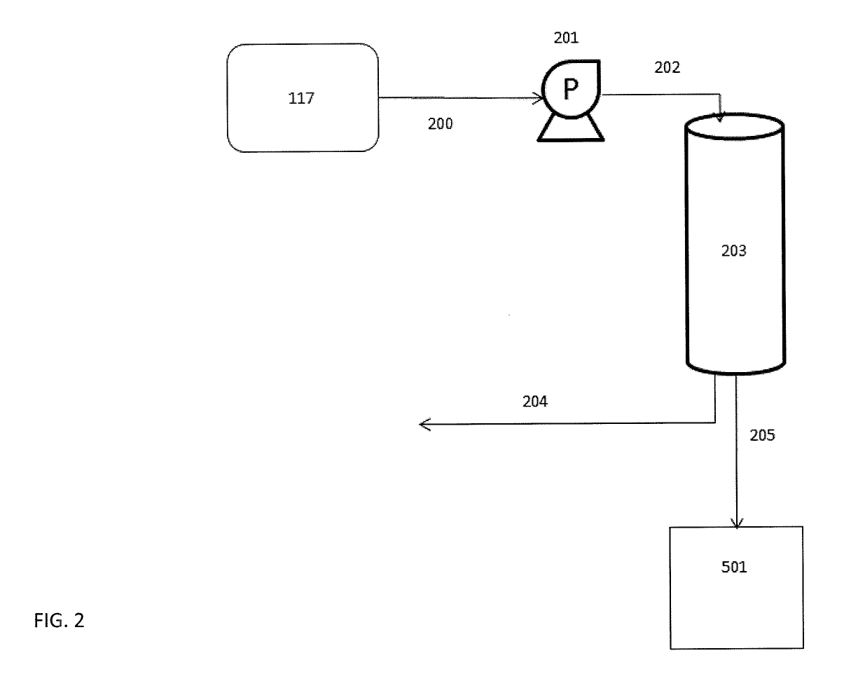

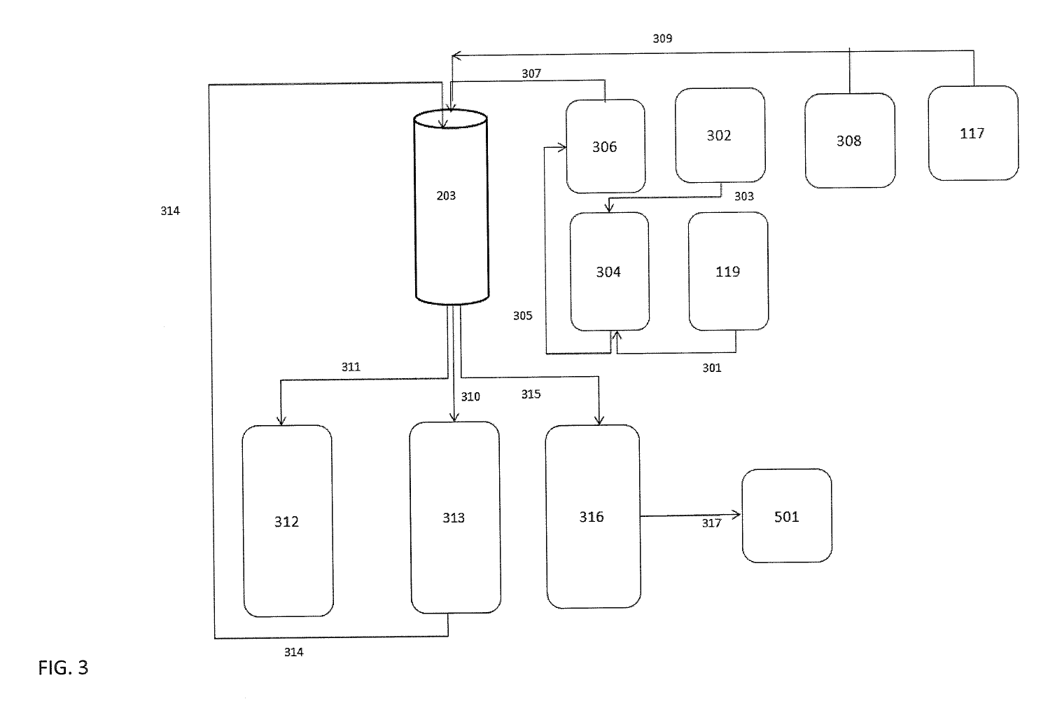

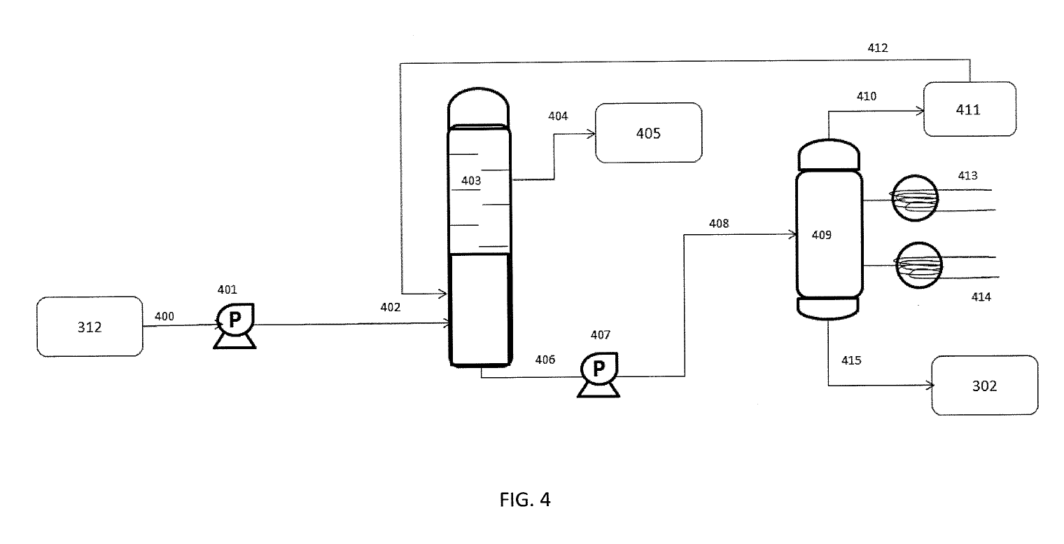

The generation of fertilizing formulations from seawater involves selective extraction of fertilizing chemicals/plant nutrients such as K, Ca, S, Mg using ion exchange materials or any ion selective extraction process (FIG. 2) followed by recovering and regeneration of ion exchanged materials using an innovative processes that enables the commercialization of the discovery (FIGS. 2 and 3). The fertilizing formulation produced at the end of the process is concentrated or purified to market specifications if needed, while minimizing the wastage and maximizing the recycling and reuse of the chemicals/water involved (FIGS. 4, 5, 6, and 7). The full processes along with the unexpected results and related details are described henceforth.

Sea water and seawater bitterns could be used as a source for fertilizing chemicals, especially for K, Ca, Mg and S, however, we recognized that seawater reject from desalination methods is the most appropriate source for generating fertilizing chemicals, as desalination methods not only provide concentrated sources of fertilizing chemicals, but also provide significant amount of fresh water required to generate the fertilizing formulations and save the energy required for pumping and processing. Further, seawater reject as a natural resource eliminates the need for mining and enables seamless extraction of minerals without harming the environment. Some of the popular seawater desalination techniques include multistage flash distillation, multiple effect distillation, nano-filtration, vapor-compression, solar desalination, forward osmosis (FO) and reverse osmosis (RO). Of all the existing methods, the RO based desalination methods are widely used across the globe due to the fact that the energy required for producing unit volume of water using this method is significantly less than other methods. The discharge from the RO desalination units contains high salt concentrations that can be used as a feed for recovering fertilizing elements/chemicals such as K, S, Ca and Mg. Therefore, integration of desalination units along with liquid fertilizers producing plants provides an innovative methodology for generating both liquid fertilizers and potable water at lower cost. At present, several countries in the world are facing severe water crisis, and (plan to) produce fresh water with the help of seawater desalination units. Ironically, many of these countries (e.g., USA, China, India) also import fertilizing chemicals, and may enormously benefit from our innovation.

The present methods and system allow for obtaining potassium ions along with at least phosphorus ions, ammonium ions, sulfur ions, calcium ions, magnesium ions, micronutrients or any combination thereof at concentrations usable for producing fertilizer. In some embodiments, the concentration of N is within a range of 0-100 g/L, a concentration of P₂O₅ is within a range of 0-400 g/L, a concentration of K₂O is within a range of 2 g-250 g/L, a concentration of S is within a range of 0-180 g/L, a concentration of Ca is within a range of 0-20 g/L, a concentration of Mg is within a range of 0-20 g/L, and a concentration of impurities and micronutrients is within a range of 0-20 g/L (which may also be exogenously introduced appropriately as per given plant nutritional/growth requirements). The elements nitrogen (N), phosphorous (P) and potassium (K) are considered as primary nutrients for plant growth, while the elements such as Calcium (Ca), Magnesium (Mg) and Sulfur (S) are considered as secondary nutrients. It is to be mentioned that elements such as Boron (B), Copper (Cu), Iron (Fe), Chloride (Cl), Manganese (Mn), Molybdenum (Mo), and Zinc (Zn) are considered as micro nutrients (typically these are required in smaller quantities for plant growth). In other embodiments, the phosphorus ions, the ammonium ions, the potassium ions, the sulfur ions, the calcium ions, the magnesium ions, and other micronutrients and impurities having a cumulative concentration of 1-800 g/L. Here the cumulative concentration is defined simply as additive concentrations of individual elements/nutrients. For example, if the concentration of nitrogen (N), phosphorous (P₂O₅), and potassium (K₂O) is 10 g/l, respectively, the cumulative concentration of corresponding NPK liquid fertilizer is calculated as 30 g/l. One could also consider expressing cumulative concentration as total dissolved solids (TDS) content and calculate it in terms of weight percentage, i.e., weight of solute/weight of the solution×100%. For example, a liquid fertilizer composition weighing 40 g of plant nutrients dissolved in 60 g of water is said to have 40 weight % of TDS. The maximum TDS content in our liquid fertilizer compositions may be 40 weight %, but preferably in the range of 2-30 weight %.

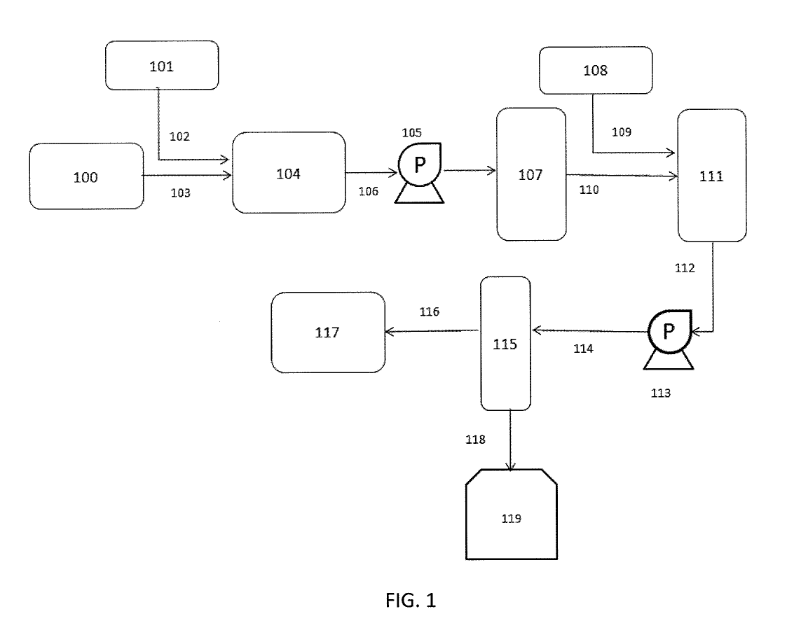

The simplified process flow diagram of RO seawater desalination system is shown in FIG. 1. An intake unit 100 pumps seawater via a pipeline 103, while flocculants 101 are pumped via a line 102 into a flocculation tank 104. The particulate matter and organic contaminant are filtered through multimedia filters 107. The anti-scaling agents 108 are added through a line 109 to avoid any unwarranted precipitation. The smaller particulates forming after the addition of anti-scaling agent are filtered through a line 110 and a porous cartridge filter 111. A booster pump 113 is used to pump pretreated seawater through a line 114 for the desalinating RO unit comprising a reverse osmosis membrane and a flow battery 115. The reverse osmosis membrane desalinates the seawater, and a seawater reject stream 117 via a stream line 116 is directed to potassium extraction unit for further processing. Clean water generated from the battery of RO membranes is carried through a line 118 to a storage unit 119 and part of it may be used for processing fertilizing chemical formulations.

The seawater reject stream 117 comprises 1.4-2.0 times concentrated seawater and will be used as a source for extracting fertilizing chemicals/plant nutrients, while a fraction of potable water from a stream source 119 will also be used as part of the process (FIG. 2). The fertilizing chemicals K, Ca and/or Mg exist as metal ions, while S exists as sulfate anion. The ion exchange or precipitation methods can be used to selectively separate each of the cationic or anionic elements. For example, potassium can be selectively recovered using both natural, modified and synthetic sorbents such as class of Zeolites (or alumino silicates) known as Clinoptilolite, Zeolite X, Zeolite Y, Zeolite W, Zeolite XY, Zeolite CH, Zeolite A, Zeolite 3A, Zeolite 4A, Zeolite 13X, ZSM-5, mica. The synthetic sorbent materials include aluminum silicates (or synthetic Zeolites) of defined Al/Si ratios, hydrated titanium dioxide containing 5 to 40 mole percent of zirconium hydroxide, manganese oxide co-precipitated with zirconia lithium aluminate intercalates, crystalline silicotitanate (CST), niobium substituted silicotitanate, tin antimonite, lithium magnesium sodium fluoride silicate, magnesium sodium fluoride silicate and so on. As many of the sorbent/ion exchange materials exist in powdered form, and may not often be conducive for commercial usage may be agglomerated or granulated using an inorganic and polymeric binders (and cross linkers) or through variations in column designs. The examples of inorganic binders include silicates, aluminates, zirconates, and titanates, while the examples of polymeric binders include poly vinyl alcohol, polyvinylidene fluoride, polyvinylidenedifluoride, ethylene/butyl acrylate copolymer, poly(vinyl alcohol) (PVA), poly(acrylic acid) (PAA), poly(methyl methacrylate) (PMMA), Polybutadiene, Poly butadiene acrylonitrile (PBAN), carboxyl terminated polybutadiene (CTBD), hydroxy terminated polybutadiene (HTBD), polyurethane and several others known in the art. The cross-linking agents in conjunction with binders further enhance the crush strength of the granules. For examples, some of the inorganic binder mentioned above can be cross linked using divalent metal ions such as Zinc, Barium, Manganese and iron, similarly aforementioned polymeric binders can be cross-linked using at least one cross linking agents comprising: carbooxylates, diols, acetyl acetonates, aldehydes, acrylamides, esters, or diamines. Further, during the granulation, it is also possible to introduce filler materials to advantageously accomplish certain desirable properties, which may include increasing the crush strength, binding strength, loading capacities of ion exchange materials, selective absorption/elution towards certain cations or anions, surface area of the particles, and mass transfer during ion exchange process, lowering the requirement of active ingredients (i.e., particulates of ion exchange materials that selectively recover potassium), and several other properties related to granulation and scalability known to those skilled in the art. Further, filler material could be well dispersed with ion exchange material in a granule or may be used as a core part of the granule. For example, ion exchange materials may be coated as a shell on top of an inert filler material. The filler materials could be organic/polymeric or inorganic and may be porous or non-porous in nature. The particle size of inert materials could be comparable to ion exchanger materials used, or may be bigger or smaller as deemed required by targeted functionality. Some of the organic filler materials may be inert and do not participate in any ion exchange process or could be active and complement the ion exchange process used for generating fertilizing chemicals. For example, a filler material that selectively absorbs sulfate ions could be mixed with potassium ion exchange material so that both sulfate and potassium are simultaneously recovered from seawater. The filler materials that are organic may include resins, polymers, or anion exchange materials. Some examples of inorganic materials may include diatomaceous earth, various forms of silicates, aluminates, metal oxides, mixed metal oxides such as alumina, silica, titanium, zirconium, clays, zeolites, and calcium carbonate and the like.

The agglomerates or granulates may exist in various forms such as monolithic discs, granules, beads, core/shell type, extradites, powders and the like, with large particles sizes, generally from 100-2000 microns, preferably, 150-1000 microns or 250-800 microns. In addition to these polymers, multiple filler materials/additives may be used to enhance the properties (e.g., porosity or surface area or crush strength or mass transfer or loading capacities etc.) of the sorbents as mentioned above. The weight % of binder with regard to sorbent may range from 4% to 20%.

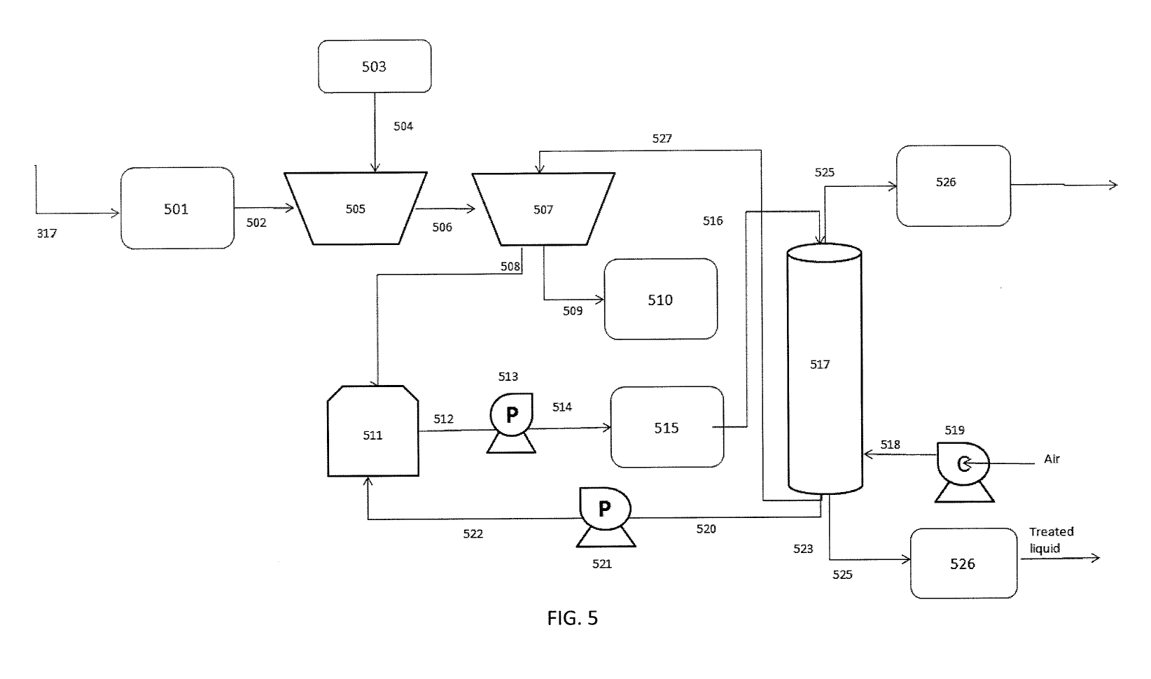

A stream 117 is pumped through a feed pump 201 through lines 200 and 202 at flow rates ranging from 4 BV/h to 20 BV/h into an ion exchange column 203 comprising sorbent materials as discussed above, especially Clinoptilolite. The ion exchange column 203 preferentially recovers potassium, albeit, certain amounts of Na, Mg, and Ca are trapped along. The seawater depleted of potassium is reverted back to the sea through a line 204 if ammonium concentration in the depleted seawater is below 50 ppm, preferably below 20 ppm. The seawater with ammonium concentration exceeding 50 ppm is stored in storage tank 501 for further processing as shown in FIG. 5.

The ion exchange column 203 fully loaded with potassium, sodium and other fertilizing chemicals was stripped with ammonical salt solution of a different concentration stored in a tank 302. The ammonical salt solution used may contain at least one or more salts in the form of sulfates, phosphates, carbonates, bicarbonates, carboxylates, nitrates, chlorides, silicates. Some of the preferred ammonium salts include ammonium sulfates, di-ammonium phosphate, ammonium carbonate, ammonium bicarbonate, and ammonium chloride. The concentration of the ammonium salts in the stripping solution can be varied. Here, it was surprising that the concentration of ammonical solution can be advantageously used to further separate fertilizing chemicals from sodium trapped into the ion exchange material. Indeed, presence of sodium in fertilizing chemicals is unwarranted and detrimental to plants and prevents direct generation of liquid fertilizer as a product from seawater. The preferred concentrations of ammonical salt solutions range from 0.1 to about 6M or 3000-180,000 ppm. It was discovered that ammonical salts with concentration below 1M, preferably, below 0.75M tend to selectively strip unwanted sodium salt preferably and enable the generation of purer form of liquid fertilizers. The potassium salts can be recovered using high concentration of ammonium salts either as pure solution or a combination of various ammonium salts (1-6M). The temperature of the solution may impact the elution profiles, however, it is possible to strip the column anywhere ranging from ambient conditions to 100° C., preferably from 45 to about 95° C.

Ammonical salt solution from storage tank 302 is pumped into a mixer 304 though a line 303, where clean/DI water from tank 119 is drawn into mixer 304 through a line 301 to make up ammonium strip solution with required concentration. Then ammonium salt solution of targeted concentration is pumped through a line 305 to a storage tank 306 or directly into fully loaded ion exchange column (line 305 into exchange column 203). In one of the preferred embodiments, sodium sulfate rich solution from the stripped ion exchange column 203 is collected in a tank 313 through a line 310, i.e., when ammonium sulfate was used as a strip solution. A line 311 is used to draw the liquid fertilizer from ion exchange column 203 into a storage tank 312. The sodium sulfate solution from tank 313 is passed through ion exchange column 203 through a line 314. Tank 313 may contain other sodium salt rich solutions such as chloride, carbonate, bicarbonate, phosphate, had corresponding ammonium salts have been used to selectively strip the sodium from the sorbent. The NaCl wash solution 308 from a storage reservoir followed by sea water reject from 117 is passed through a line 309 into ion exchange column 203 to recover ammonia from the column into a tank 316 through a line 315. A line 317 containing ammonia rich solution is sent to ammonia recovery unit at a collection reservoir 501.

NaCl wash solution 308 could be substituted by several other solutions such as simple seawater or concentrated seawater or seawater mixed with additional amounts of salts, or sodium carbonate, or sodium bicarbonate or any inorganic buffer solutions with pH above 8.5. The ionic strength of salt solution or pH solution or both play a role in ammonia recovery process efficiency. Alternatively, the ammonium rich solution could be recovered from the column using the sodium sulfate rich fraction in part or full followed by either seawater or SWRO reject, or concentrated seawater or seawater enriched with sodium chloride solution. The ammonia from the sorbent could also be stripped directly using hot air or steam without having to use any salt solutions. For example, the Na salts solutions used to strip ammonia from the column can be NaOH, CaO, Ca(OH)₂Na₂CO₃, NaHCO₃, Na₂SO₄ and NaCl. Preferably, the ammonia stripping solution has a concentration ranging from about 0.5 to about 5M, at a temperature ranging from about ambient temperature to about 120° C. The ambient temperature represents the temperature of the surrounding environment or air, unlike room temperature, which is climate-controlled indoor temperature, ambient temperature represents outside temperatures. Therefore, ambient temperatures may change according to seasons and regions. For example, ambient temperatures tend to be higher in summer than in winter, similarly countries away from equator will have colder ambient temperatures than countries that are close to equator.

Also surprising is that liquid fertilizers of different compositions such as NK, NPK, NKS, and NPKS can directly be generated off ion exchange column after Na strip followed by a product cut 312 simply by using combination of ammonium salts (either mixed together or used sequentially one after the other) as strip solutions. All our experimental data indicate such a direct synthesis of liquid fertilizers do not result in any discernable adverse effect on the performance of ion exchange columns. It was also found that simply by combining distinct aliquots of product, various liquid fertilizer formulations of commercial interest can be obtained.

Product cut 312 could be further concentrated (1.5 to 20 times) or formulated with the help of solvent extraction to generate liquid fertilizers of varying concentrations and compositions. The product cut is optionally concentrated by various de-watering methods to reduce the volume of the final product to be packaged and distributed for commercialization purposes. Some of the de-watering methods also help us re-constitute the composition/concentrations of liquid fertilizer formulations or conveniently introduce micronutrients and/or pesticides into the formulation. For example, we could use acetone (or other ketones) to preferably separate ammonium sulfate from the product cut, where ammonium salt preferably migrates into the organic phase with simultaneous concentration/precipitation of potassium salts. The ratio of the product to that of the solvent was critical in controlling the final liquid fertilizer formulation. The preferred aqueous/organic phase ratios in case of acetone range from 1:0.5 to 1:4. We found that solvent extraction methods could be utilized to precipitate the fertilizing chemicals (e.g., potassium/ammonium sulfate or potassium/ammonium phosphate or combination thereof). It was found that alcohols such as methanol can also be used to concentrate or precipitate liquid fertilizers. The preferred aqueous to organics ratio in case of methanol is in the range of 1:0.5 to 1:2. It seems, several hydrophobic/hydrophilic organic solvents based on ketones or alcohols or carboxylic acids or carboxylates or amines or esters or hydrocarbons or their combinations could be utilized to generate concentrated liquid fertilizer formulations. Typically, the solvents enriched with ammonium salts could be regenerated and recycled using several methods; fractional distillation is one such method. FIG. 4 details the steps involved in concentrating our product using various solvents.

Product cut 312 comprising low concentration fertilizing formulation is pumped from storage through lines using a feed pump 401 in to a liquid-liquid extractor column 403. Required amount of solvent is pumped into the extractor column using a line 412. The flow of the solvent is varied to get required ratio of solvent to product cut and counter current of flow is maintained for proper mixing. Concentrated product cut is collected at a storage tank 405 through a line 404. Aqueous solvent was pumped through a feed pump 407 and lines 406 and 408 in to a short cut distillation column 409. The short cut distillation unit is heated with steam heaters 413 and 414. Evaporated solvent is condensed in a storage tank/condenser 411 through a line 410. Line 412 carries the solvent back to liquid-liquid extractor column 403. Ammonium sulfate solution is drained out of the short cut distillation unit through a line 415 in to storage tank 302. Alternately, the low concentration product cut 312 could be concentrated 1.5-20 fold using standard reverse osmosis and forward osmosis equipment/methods.

Post recovery of the liquid fertilizer product, the sorbent is loaded with ammonium ions and need to be replaced with sodium ions before reusing it for recovering fertilizing chemicals from the seawater in the subsequent cycle. The exemplary process flow diagram of stripping, recovering and recycling ammonia is shown in FIG. 5. Ammonia rich solution from line 317 is stored in a tank 501. From tank 501, a line 502 takes it to a tank 505, where the pH of the solution is adjusted between 9-11.5 using a variety of bases such as metal oxides (e.g., calcium oxide), metal hydroxides (e.g., calcium hydroxide, sodium hydroxide), metal carbonates (e.g., calcium carbonate, sodium carbonate) or combination of any of the two to release ammonia. For example, lime/slaked lime/caustic soda/limestone are introduced in a slurry form from a reservoir 503 through a line 504 to a precipitator 505. The solids settled at the bottom of settling chamber as slurry is transferred through a line 506 to a clarifier 507. The precipitate (e.g., gypsum, calcium phosphate or calcium chloride) is separated from the mother liquor in clarifier 507 and collected in a sludge tank 510 through a line 509. The mother liquor is transferred from clarifier 507 through a line 508 to feed storage a tank 511. This is fed through lines 512 and 514 via a pump 513 to a heat exchanger 515. Feed liquid is pumped through a line 516 to the top of an air stripping column 517. Air or any inert gas is pumped through an air blower pump 519 and a line 518 from the bottom of airstrip column 517. Air/Inert gas containing ammonia is sent though a line 525 to an off gas treatment tank 526 and at the same time the air is recovered back in circulation to air blower pump 519. Ammonia free solution with particulates is sent to clarifier 507 through line 527. Ammonia poor liquid is transferred through a line 523 to a check point 524 for analysis and further treatment if required and let out to affluent. Part of ammonia rich solution is re-circulated back from air stripper column 517 through a line 520 to a pump 521 back to an ammonia feed storage tank 511 through a line 522. The detection of ammonia at check point 524 can be but not limited to spectroscopic means.

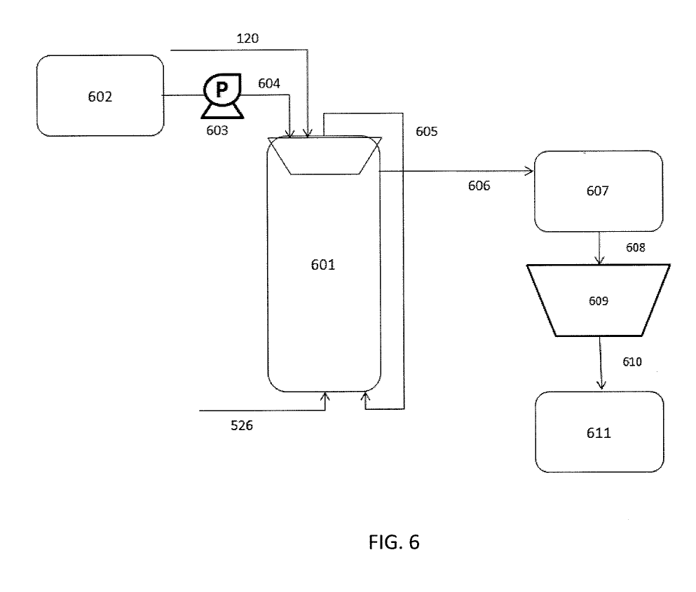

The ammonium recovered from above process shown in FIG. 5 is converted into a corresponding salt solution (e.g., ammonium hydroxide, ammonium sulfate, ammonium phosphate, ammonium carbonate, ammonium bicarbonate) and recycled back into the process as shown in FIG. 6. For example, sulfuric acid, calcium sulfate, CO₂, and phosphoric acid streams can be reacted by contacting with ammonia gas stream in a multiple stage liquid-vapor contactor, column or reactor. In a preferred embodiment, the contactor column, in a central section, sulfuric acid/phosphoric acid sprayed with nebulizer is contacted as droplets with an excess of ammonia gas in the presence of water vapor to produce ammonia sulfate or ammonium phosphate respectively. In the upper section of the contactor column, excess ammonia is scrubbed by countercurrent contact with water or acid solution. Ammonium salts solution and crystalline product formed is removed from the lower section of the contactor column.

Ammonia rich gas stream from line 526 is fed to the bottom of reaction tank 601. Concentrated acid is stored in a storage tank 602 and is fed through a dosing pump 603 in to a reaction tank 601 through a line 604. Water from RO product tank 119 is fed to the reaction tank 601 through line 120. The water is mixed with the acid as per required dilutions. Acid/water mixture is sprayed from the top of reaction tank 601 and NH₃ gas from line 526 is passed under high pressure from the bottom of tank 601. Stripped ammonia with water vapor is transferred through a line 606 to an ammonia salt solution slurry tank 607. Un-reacted ammonia gas is re-circulated back into reaction tank 601 through a line 605. Ammonium salt solution from ammonia salt solution slurry tank 607 is fed to a clarifier 609 through a line 608. Clear ammonium salt solution is transferred to a concentrated ammonium salts solution tank 611 through a line 610.

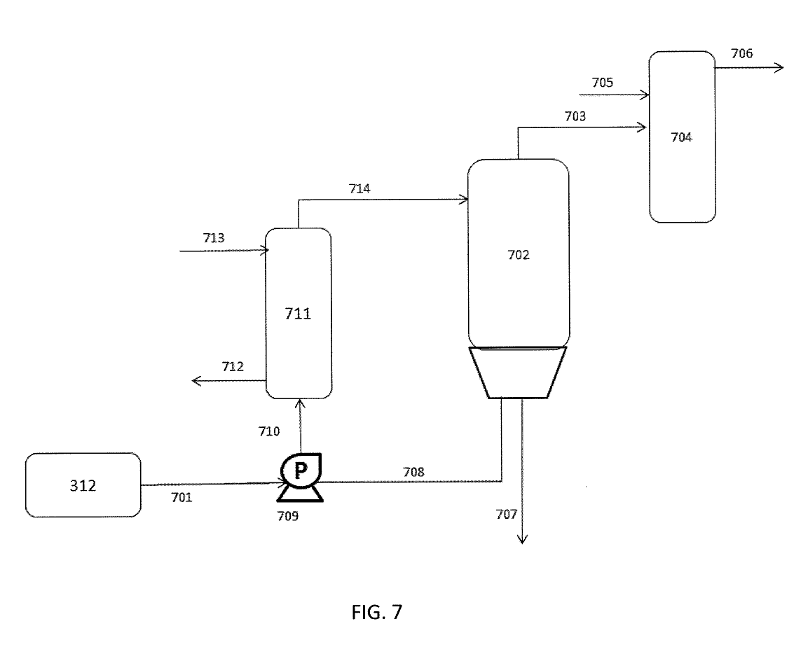

The product cut comprising liquid fertilizer formulation from storage tank 312 could be concentrated using circulating evaporator as shown in FIG. 7. The product cut is fed to a high pressure feed pump 709 through a line 701. It is transferred to a heat exchanger 711 through a line 710. Steam jet is injected in to the heat exchanger through a line 713. The solution is heated in the heat exchanger without boiling. The condensate is collected at an outlet line 712. Then the solution is flashed in to an evaporator 702 through a line 714. Dilute form of product cut is recycled back through line 708 into the re-circulating pump 709 back to heat exchanger 711 via line 710. Here the superheated solution is evaporated at lower pressure. Concentrated product is collected at the bottom of the evaporator using a line 707. The evolved gases are transferred to a barometric condenser 704 through a line 703. Condenser is cooled using coolant fluid from a line 705 and uncondensed gasses are let out using an exhaust line 706. Alternately, the liquid fertilizer formulation may be concentrated using reverse osmosis, conceptually similar to the technology described in FIG. 1 or through solvent extraction methods described in FIG. 4.

### EXAMPLES

The following examples are provided to illustrate the invention but are not intended to limit the scope of the invention.

### Example 1

The liquid fertilizers were made using seawater as a natural resource. The seawater from Bay of Bengal was used for conducting these studies (Table 1). To mimic, seawater reject from desalination plants, approximately 30% of water from seawater was evaporated and the corresponding composition is presented in table 1. We used either seawater or seawater reject from desalination plants to recover fertilizing chemicals such as K and S. The sorbent material used for producing NKS or NK, or NPK or NPKS or KS or K based fertilizers is made of alumino silicates or Zeolites, which can be modified, granulated, made synthetically or mined in nature.

TABLE 1
Composition of some key elements
in seawater and seawater reject

| | Seawater | Seawater reject |
|---|---|---|
| Elements | (ppm) | (ppm) |
| Na | 9960 | 14229 |
| K | 392 | 560 |
| Ca | 430 | 614 |
| NH4+ | 0 | 0 |
| SO4−2 | 2800 | 4000 |
| Cl− | 24000 | 34286 |
| Mg | 1290 | 1843 |
| Br | 67 | 96 |
| Sr | 8.1 | 12 |
| B | 4.45 | 6.36 |
| Li | 0.17 | 0.24 |
| Ba | 0.021 | 0.03 |
| I | 0.64 | 0.91 |
| U | 0.0033 | 0.0047 |

### Example 2

Liquid Fertilizer Contaminated with Sodium (Control):

Seawater was passed into a 40 cm long column with internal diameter (i.d.) of 1.9 cm containing 30 g of Na modified Clinoptilolite as sorbent material at ambient temperature. The particle size distribution, density and packing structure of the column influence the effective bed volume of the sorbent and its ion selective absorption properties. The potassium preferentially absorbed into column (along with Na, Ca and Mg) was eluted with ammonium sulfate above 0.5 M concentration at 80° C. The loading and stripping of solutions into the column were carried out using semi-automated peristaltic pump with flow rates typically ranging from 8-16 and 2-8 BV/h, respectively. The loading is considered complete when the absorption of fertilizing chemicals reaches a breakthrough. The liquid fertilizer product cut obtained (approximately 1 to 1.8 BV) thereby has an approximate NKS composition of 22:11:15 (g/l) and is contaminated with significant quantities of Na (>6 g/l). In other words, the fertilizing composition is contaminated with 25 weight % NaCl and may not be acceptable or optimal/ideal for fertilization purposes (Table 2).

### Example 3

Liquid Fertilizer with Low Sodium Levels:

The seawater was passed on to Na activated Clinoptilolite to recover potassium at ambient temperature as described in example 2. However, the potassium was eluted using ammonium sulfate salts with varying concentrations (<0.5 M solution followed by >0.5 M) at room temperature. The liquid fertilizer comprising NKS in 14:10:15 g/l ratio was collected as a product and the NaCl impurity in the product cut (i.e., 0.3 g/l) was surprisingly low, almost 20 times lower than example 2. The presence of extremely low sodium chloride (0.76 g/l or 1.9 weight % of NaCl) makes this formulation most preferred for liquid fertilization purposes (Table 2).

### Example 4

Liquid Fertilizer with Low Sodium Levels and Higher K and S Values:

The seawater was passed on to Na activated sorbent to recover potassium at ambient temperature as described in example 2. The potassium was eluted using ammonium sulfate salts with variation in their concentrations (<0.5 M solution followed by >0.5 M) at elevated temperature, 60-70° C. The temperature variation altered the NKS composition of the final product cut and liquid fertilizer compared to example 3, has higher concentration of potassium i.e., 8:8:14 g/l (Table 2).

### Example 5

Liquid Fertilizers with K and S:

One liter of liquid fertilizer NKS as made in example 3 was treated with 5 to 30 g of lime. Based on the amount of lime added, the pH was adjusted to either 8.5 or 9.5 or 10.5 or 11.5 and heated at 55° C. or above for minimum of 2 h with constant stirring to separate varying quantities of N as ammonia, while generating calcium sulfate as a solid by product. At the end of reaction, various NKS liquid fertilizer formulations comprising Ca as an additional micro-nutrient in the range of 0.05 to 1.0 g/l were generated. The composition of NKS liquid fertilizers processed at pH 8.5, was 6:9:13; pH 9.5 was 0.14:10:4; pH 10.5 was 0.05:10:3 and pH 11.5 was 0.02:11:3.

### Example 6

Liquid Fertilizers with N and K:

Potassium was preferentially recovered/loaded into the sorbent as discussed in example 2. The sorbent was stripped using ammonium chloride solution above 1 M concentration. The resultant product has NK composition of 6:6 and was contaminated with sodium chloride. The Na and Cl impurities in the solution were found to be about 0.8-1 g/l of Na and 2-5 g/l of Cl⁻.

### Example 7

Ammonia Recovery from Liquid Fertilizers and Regeneration:

After recovery of liquid fertilizers as in example 2, the subsequent passage of brine solution led to 3-4 bed volumes of ammonia rich solution (2000-6000 ppm). The ammonium from this solution was evolved by adding lime or caustic soda (i.e., to raise pH above 8.5) followed by heat and/air stripping method. For, example the thermal evolution was accomplished by refluxing the solution in RB flask and recovering the condensed ammonia from a distillation column until the brine solution has ammonia concentration less than 50 ppm. The ammonium hydroxide solution obtained was acidified using 0.2-0.5 M sulfuric acid to obtain ammonium sulfate solution. Alternately, we have also subjected the pH adjusted brine solution to air stripping in a glass column (40 cm in length and 1.9 cm internal diameter) packed with glass beads up to 20 cm height to evolve ammonium from the brine solution until the ammonia in brine solution is less than 50 ppm. We recovered calcium sulfate as a by-product when lime was added to the brine to adjust the pH.

### Example 8

Recovery of Sulfate from Seawater:

The recovery of ammonia using brine solution as in example 7 was completed by passing seawater or SWRO reject. The ammonia recovered into seawater or SWRO reject was evolved by combining this ammonia laded seawater or SWRO reject into the calcium rich and high pH solution obtained in example 6. The reaction was carried out at 60-80° C. with continuous stirring on magnetic stirrer with heating mantle. This process enabled the recovery of an additional calcium sulfate; where calcium comes from CaO/Ca(OH)₂ and sulfate comes from seawater or SWRO reject.

### Example 9

Ammonia Recovery from Sorbent and Re-Cycle:

Post recovery of liquid fertilizers using ammonium salts as mentioned in example 2, sorbent was treated with sodium carbonate/sodium bicarbonate buffer (saturated) at pH 9.5 to efficiently recover ammonia in smaller bed volumes. The resultant solution was heated up to 100° C. to evolve ammonia and regenerate sodium carbonate/bicarbonate buffer for subsequent stripping of ammonia from the column prior to loading the column for recovering fertilizing chemicals. The regenerated buffer concentration was adjusted by adding additional amounts of salts either in the form of carbonate or bicarbonate to maintain the pH or ionic strength of the solution if required. Alternatively the buffer solution can be re-used without replenishing the additional amount of salts for seven to eight cycles continuously.

### Example 10

Regeneration of Strip Solution:

The ammonia recovered from the brine solution using air striping as detailed in example 7 was converted to ammonium sulfate or ammonium phosphate by scrubbing it with appropriate acids. We have successfully generated 0.01 to 2M ammonium sulfate and ammonium phosphate solutions from 1 liter of brine comprising 2000-6000 ppm of ammonia. In an alternative approach, the acids were added drop-wise, to ammonium hydroxide solution generated as in example 7 until pH reached to 5.8 to 6. The regenerated ammonium salts were re-cycled as shown in FIG. 6, stream 611.

### Example 11

Liquid Fertilizer Formulation with Equal Ratios of NPKS:

Potassium was adsorbed from the seawater/SWRO reject along with other cations followed by its preferable recovery at ambient temperature as detailed in example 2. The sorbent was treated with low concentration of ammonium sulfate to recover sodium sulfate. However, interestingly, we found that by combining equal volumes and concentrations of ammonium sulfate and di ammonium phosphate or a mixture of the two (>0.5M), it is possible to directly generate liquid fertilizer comprising NPKS in 9:9:9:9 ratio (Table 2). The ratio of potassium in the formulation could be increased when the ammonium salt solution was used at higher temperature (preferably 50° C.-90° C.).

### Example 12

Modifying Composition of Liquid Fertilizer Formulation:

The NPKS liquid fertilizer was obtained as detailed in example 11. The eluted volumes that are low in potassium and high in phosphorous were combined to generate the NPKS formulation of 4:13:2:4 (Table 2). To this end, we pooled the aliquots of product cut comprising high concentrations of phosphorous to generate above customized liquid fertilizer formulation.

### Example 13

Phosphorous Rich NPK Liquid Fertilizer Formulation:

Potassium was adsorbed from the seawater/SWRO reject along with other cations onto the sorbent. The low concentration ammonium carbonate was used to recover sodium carbonate selectively. The product cut comprising K was recovered using equal volumes and concentrations of ammonium sulfate and di ammonium phosphate (>0.5M) and the fractions rich in phosphorous were pooled together to directly generate liquid fertilizer rich in phosphorous with NPK ratios of 5:43:6 (Table 2). The ratio of sulfur in the formulation was low i.e., 0.5 g/l. The formulation generated using this combination of salts of ammonium was carried out at ambient temperature.

### Example 14

Phosphorous Poor NPK Liquid Fertilizer Formulation:

Potassium from seawater or seawater reject was selectively extracted into the sorbent as detailed in example 2. The sodium sulfate solution was selectively recovered using lower concentrations of ammonium salt (<0.5M). Subsequently, potassium was recovered using sulfate and phosphate salts of ammonium, where the volume and ratio of sulfate salt to that of phosphate salts was 1:2 with total concentration being in the range of 0.5 to 2M. Around 60% of the product generated around the peak concentrations was simply pooled to generate a NPKS liquid fertilizer formulation which is poor in P and rich in NK: 13:2:10:10.

### Example 15

Controlling Concentration of NPKS:

Potassium from sea water was selectively extracted into sorbent as shown in example 2 at ambient temperature. The sorbent was treated with concentrated salts of ammonium sulfate and ammonium phosphate mixed in 3:1 molar ratio to accomplish targeted concentration/ionic strength. The NPKS ratio of the liquid fertilizer product obtained thereby has the g/l ratio of 7:12:5:13. However, when 60% concentrated fractions of N, P and K in the product cut were pooled together, we were able to obtain NPKS liquid fertilizer formulation of 10:10:10:10 (Table 2). This particular formulation/NPK ratio constitute one of the most commonly used forms of liquid fertilizer. We used thermal methods to double the concentration of this liquid fertilizer formulation with NPK ratios 20:20:20 (this formulation comprises 20 g/L of sulfur).

### Example 16

Liquid Fertilizer with Only NK Composition:

The seawater was passed onto Na activated sorbent to recover potassium based fertilizing chemicals at ambient temperature. After selectively extracting sodium carbonate from the sorbent using low concentrations of ammonium salts i.e., <0.5M, the potassium was recovered using >1M bicarbonate ammonium based salt solution followed by ≦1M concentrations of di or mono ammonium phosphate. The liquid fertilizer pooled as product cut had NPK ratio of 15:20:10. By selectively pooling the initial 45% of the product cut and stirring it continuously at room temperature specified NK liquid fertilizers such as 10:15 was generated.

### Example 17

Enriching K of NKS Fertilizers Using Solvent Extraction:

The seawater or brine solution was passed onto sodium activated sorbent to preferentially extract potassium. The potassium entrapped into the sorbent along with other elements was selectively recovered from the sorbent using varied concentrations of ammonium salts (<0.5 to 3M) as in example 2. The liquid fertilizer thus generated had NKS composition as 10:5:12 g/l with low NaCl contamination. This product cut was subjected to solvent extraction by mixing it with different weight ratios of acetone ranging from 1:0.25 to 1:5, preferentially 1:1.5. The concentrated NKS liquid fertilizer thus obtained was enriched with potassium by almost 3 times (N and S contents were reduced by 2.5 times), i.e., 4:14:5 (N:K:S). The organic phase laden with aqueous ammonium sulfate and acetone were separated, recovered and recycled.

### Example 18

Concentrating NPK Liquid Fertilizer Using Organic Solvents:

The brine solution was passed onto Na activated sorbent to recover potassium as a fertilizing chemical at ambient temperature. The potassium as liquid fertilizer was recovered from the sorbent using higher concentrations of ammonium salts (>1M), preferably using phosphate based ammonium salts. The NPK liquid formulation obtained had composition of 10:20:8. The aqueous product cut was concentrated using acetone at different weight ratios of 1:0.5 to 1:5, preferably 1:0.8. Surprisingly, the liquid formulation after addition of acetone was concentrated 10 times. The ratios of N, P and K in the concentrated aqueous phase i.e., product cut were found to be 100:200:80 g/l respectively. The organic layer was separated, and acetone was selectively recovered and recycled (Table 2).

### Example 19

Concentrating NPKS Liquid Fertilizer Using Acetone:

The brine solution was passed onto Na activated sorbent to recover potassium as a fertilizing chemical at ambient temperature. The potassium as liquid fertilizer was recovered from the sorbent using higher concentrations of ammonium salts (>1M), preferably a mixture of equal concentrations and volumes of both phosphate and sulfates. The NPKS liquid formulation obtained thereby had composition of 6:15:5:6. The product cut was concentrated using acetone at different weight ratios of 1:0.5 to 1:5, preferably 1:1.5. Surprisingly, the liquid formulation after addition of acetone was concentrated 15-20 times. The ratios of N, P, K and S in the concentrated aqueous phase i.e., product cut were found to be 90:300:80:90 g/L, respectively. The acetone was recovered and recycled from the organic phase (Table 2).

### Example 20

Precipitation of NPK Liquid Fertilizer Using Methanol:

The potassium adsorbed by a sorbent from seawater was recovered using ammonium salts at ambient temperature. The sodium was selectively stripped from the sorbent using sulfate salts of ammonium at lower concentrations, preferably <0.5M. The potassium as liquid fertilizer was recovered from the sorbent using higher concentrations of ammonium salts (>1M), preferably only phosphate based ammonium salts. The NPK liquid formulation obtained had composition of 10:20:8. The product cut was concentrated using an alcohol preferably methanol at different weight ratios of 1:0.5 to 1:5, preferably 1:0.8. The liquid formulation after addition of methanol was precipitated. The ratios of N, P and K in the solid product cut were found to be 90, 250 and 40 g/l respectively. The methanol was recovered and recycled from the organic phase (Table 2).

### Example 21

Precipitating NPKS Liquid Fertilizer Using Methanol:

The brine solution was passed onto Na activated sorbent to recover potassium as a fertilizing chemical at ambient temperature. The potassium as liquid fertilizer was recovered from the sorbent using higher concentrations of ammonium salts (>1M), preferably a mixture of equal concentrations and volumes of both phosphate and sulfates. The NPKS liquid formulation obtained had composition of 6:15:5:6. The product cut was concentrated using methanol at different weight ratios of 1:0.5 to 1:5, preferably 1:1.5. The ratios of N, P, K and S in the solid product cut were found to be 100, 300, 100 and 100 g/l respectively. The methanol was recovered and recycled from the organic phase (Table 2).

### Example 22

The finely powdered particles of Zeolite were washed with water and treated with saturated NaCl solution above 100° C. for 10 h for activation. The excess salt solution was decanted post activation, washed and dried in an oven at 110° C. for 6 h. To 10 g of the dried powder 5 wt % polyvinyl alcohol polymer, and 10 wt % water was mixed. The slurry obtained thereby was extruded through 600 μm mesh plates. The extruded granules were cured in two stages, 2 h at 60° C. followed by 2 h at 120° C. The dry granules obtained were washed and sieved and dried in an oven at 110° C. The granulated particles exhibited higher crush strength compared to parent non-granulated Zeolite particles.

TABLE 2
Comparison of Liquid Fertilizer Composition using
Various Potassium Recovery Solutions

| | Liquid Fertilizer Composition (g/l) | | | | |
|---|---|---|---|---|---|
| Example # | Fertilizer Type | N | P₂O₅ | K₂O | S |
| Example 2 | NKS | 22 | 0 | 11 | 15 |
| Example 3 | NKS | 14 | 0 | 10 | 15 |
| Example 4 | NKS | 8 | 0 | 8 | 14 |
| Example 5 | NKS | 0.14 | 0 | 10 | 4 |
| Example 6 | NK | 6 | NA | 6 | NA |
| Example 11 | NPKS | 9 | 9 | 9 | 9 |
| Example 12 | NPKS | 4 | 13 | 2 | 4 |
| Example 13 | NPK | 5 | 43 | 6 | 0.5 |
| Example 14 | NPKS | 13 | 2 | 10 | 10 |
| Example 15 | NPKS | 20 | 20 | 20 | 20 |
| Example 16 | NK | 10 | 0 | 15 | 0 |
| Example 17 | NKS | 4 | 0 | 14 | 5 |
| Example 18 | NKS | 100 | 200 | 80 | 0 |
| Example 19 | NPKS | 90 | 300 | 80 | 90 |
| Example 20 | NKS | 90 | 250 | 40 | 0 |
| Example 21 | NPKS | 100 | 300 | 100 | 100 |

What is claimed is:

1. A method of extracting compounds from a brine solution comprising:
a first step of loading the brine solution onto an ion exchange system to preferentially bind mono or divalent ions such as sodium ions, potassium ions, calcium ions, or magnesium ions;
a second step of using an eluent with a first concentration after the first step resulting in a sodium rich salt solution; and
a third step of using an eluent with a second concentration after the second step to generate a fertilizer composition comprising potassium ions along with at least phosphorus ions, ammonium ions, sulfur ions, calcium ions, magnesium ions, micronutrients or any combination thereof.

2. The method of claim 1, further comprising reclaiming the ammonic solution from the elution steps in a recovery process using eluent retained by the ion exchange system.

3. The method of claim 1, wherein the brine solution is concentrated seawater from a desalination process.

4. The method of claim 1, wherein the liquid fertilizer composition comprises at least one or more of the following ions: the phosphorus ions, the ammonium ions, the potassium ions, the sulfur ions, the calcium ions, the magnesium ions, micronutrients and impurities having a cumulative concentration of 1-800 g/L.

5. The method of claim 1, wherein the liquid fertilizer composition comprises at least one or more of the following ions: the phosphorus ions, the ammonium ions, the potassium ions, the sulfur ions, the calcium ions, the magnesium ions, micronutrients and impurities having a cumulative concentration of 2-300 g/L.

6. The method of claim 4, wherein a concentration of N is within a range between 0-100 g/L, a concentration of P₂O₅ is within a range of 0-400 g/L, a concentration of K₂O is within a range of 2-250 g/L, a concentration S is within a range of 0-180 g/L, a concentration of Ca is within a range of 0-20 g/L, a concentration of Mg within a range of 0-20 g/L, and the micronutrients and impurities are within a range of 0-20 g/L.

7. The method of claim 1, wherein the ion exchange system comprises an ion exchange material, and optionally at least one binder, one cross-linking agent and/or filler.

8. The method of claim 7, wherein at least one binder and/or at least one cross-linking agent comprises 4 to 20% of the ion exchange material by weight.

9. The method of claim 7, wherein the ion exchange material has an average particle size in the range of 100 to 2000 μm.

10. The method of claim 7, wherein the ion exchange material has an average particle size in the range of 250-800 μm.

11. The method of claim 1, wherein the eluent is an ammonic solution that comprises at least one ammonium salt in the form of sulfates, phosphates, carbonates, bicarbonates, carboxylates, nitrates, chlorides, or combinations thereof.

12. The method of claim 1, wherein the first concentration of the eluent is between 0.1 M and 3M.

13. The method of claim 1, wherein the first concentration of the eluent is below 0.75M.

14. The method of claim 1, wherein the second concentration is between 0.5 M and 6 M.

15. The method of claim 1, wherein the second step and the third step are performed at a temperature between ambient temperature and 100° C.

16. The method of claim 2, wherein the recovery process comprises stripping the ammonium ions from the ion exchange material using heat or steam or air or a strip solution or any combination thereof.

17. The method of claim 16, wherein the strip solution comprises at least one sodium-rich compound such as sodium hydroxide, sodium carbonate, sodium bicarbonate, sodium sulfate, or seawater enriched with sodium chloride, concentrated sea water or sodium chloride or a combination thereof.

18. The method of claim 16, wherein the strip solution has a concentration between 0.5 and 6 M or has high ionic strength wherein a total dissolved salt concentration may range from 3 weight % to 40 weight %.

19. The method of claim 16, wherein the recovery process is performed at ambient temperature to 120° C.

20. A method of extracting compounds from seawater comprising:
a first step of obtaining seawater reject from the seawater after desalination;
a second step of loading the seawater reject onto a ion exchange system to preferentially bind mono or divalent metal ions after the first step;
a third step of using an eluent with a first concentration of an ammonic solution between 0.1M and 3M, at temperatures ranging from ambient to 100° C. to produce a sodium rich salt solution after the second step;
a fourth step of using the eluent with a second concentration of the ammonic solution between 0.5M and 6M to generate a fertilizer composition comprising at least phosphorus ions, potassium ions, ammonium ions, calcium ions, magnesium ions, sulfur ions, or a combination thereof after the third step; and
a fifth step of reclaiming ammonium salts in a recovery process from ammonic solution retained by the ion exchange system after the fourth step.

21. The method of claim 20, wherein the liquid fertilizer composition is concentrated 1.5-20 times with at least one of organic solvent extraction, thermal methods, reverse osmosis or forward osmosis after the fourth step

22. The method of claim 20, wherein the fertilizer composition comprising at least one or more of the following ions: the phosphorus ions, the potassium ions, the sulfur ions, the ammonium ions, the calcium ions, the magnesium ions, micronutrients, and impurities having a cumulative concentration of 1-800 g/L.

23. The method of claim 20, wherein the fertilizer composition comprising at least one or more of the following ions: the phosphorus ions, the potassium ions, the sulfur ions, the ammonium ions, the calcium ions, the magnesium ions, micronutrients, and impurities having a cumulative concentration of 2-300 g/L.

24. The method of claim 20, wherein the liquid fertilizer composition derived in the fourth step has a concentration of N within a range between 0-100 g/L, a concentration of P₂O₅ within the range of 0-400 g/L, a concentration of K₂O within the range of 2-250 g/L, a concentration S within the range of 0-180 g/L, a concentration of Ca within the range of 0-20 g/L, a concentration of Mg within the range of 0-20 g/L, and concentrations of micronutrients and impurities are within the range of 0-20 g/L.

25. The method of claim 20, wherein the ion exchange system comprises an ion exchange material, and optionally at least one binder, at least one cross-linking agent and/or filler.

26. The method of claim 25, wherein at least one binder and/or at least one cross-linking agent comprises 4 to 20% of the ion exchange system by weight.

27. The method of claim 25, wherein the ion exchange material has an average particle size in the range of 100 to 2000 μm.

28. The method of claim 25, wherein the ion exchange material has a particle size between 250-800 μm.

29. The method of claim 20, wherein the first concentration and the second concentration of ammonic solution comprise at least one ammonium salt in the form of sulfates, phosphates, carbonates, bicarbonates, carboxylates, nitrates, chlorides, or combinations thereof.

30. The method of claim 20, wherein the recovery process comprises stripping the ammonium from the ion exchange material using heat or steam or air or a strip solution or a combination thereof.

31. The method of claim 30, wherein the strip solution comprising at least one sodium-rich compound, an alkaline, or an alkaline earth base.

32. The method of claim 31, wherein at least one sodium rich compound comprises sodium hydroxide, sodium carbonate, sodium bicarbonate, sodium sulfate, or sodium chloride or combination thereof.

33. The method of claim 30, wherein the strip solution has a concentration between 0.5 and 6 M or higher ionic strength wherein a total dissolved salts concentration range from 3 weight % to 40 weight %.

34. The method of claim 20, wherein the recovery process is performed at ambient temperature to 120° C.

35. The method of claim 31, further comprising recycling the sodium-rich compound after reclaiming ammonium.

36. A system for extracting compounds from desalination reject solution comprising:
a desalination reject solution source;
an ion exchange column in fluid connection with the source via a fluid connection;
an ammonic reservoir in fluid connection with the ion exchange column;
a sodium ion rich solution reservoir adapted to retain preferentially eluted sodium from the desalination reject solution;
a product reservoir adapted to retain liquid fertilizer from the ion exchange column;
an ammonia recovery chamber in fluid connection with the ammonic solution reservoir adapted to separate ammonical components from the brine solution;
a product concentrator adapted to concentrate the liquid fertilizer; and
an ammonical recovery system adapted to regenerate ammonic salt solution to be reused.

37. The extraction system of claim 36, wherein the ammonic reservoir is also in fluid connection with a dilution reservoir.

38. The extraction system of claim 36, further comprising a second product reservoir in fluid connection with the ion exchange column adapted to collect product to make liquid fertilizers containing ions of at least phosphorus, potassium, ammonium and sulfur from the ion exchange column.

39. The extraction system of claim 36, wherein the ammonical recovery system further comprises an ammonium reclamation system and/or an ammonia reclamation system.

40. The extraction system of claim 36, wherein the ammonium reclamation system comprises:
a reservoir adapted to store ammonium containing brine solution and to adjust the pH of the brine solution;
an ammonia evolving column in fluid connection with the separator reservoir adapted to reclaim purified ammonia from ammonium containing brine;
a gaseous ammonia collection reservoir in fluid connection with the ammonia evolving column;
a clarifier in fluid connection with the ammonia free brine solution adapted to remove precipitated particulates from the brine solution; and
a reaction vessel in fluid connection with the gaseous ammonia collection reservoir adapted to reclaim clean ammonium salts from the brine solution to be reused in the extraction system.

41. The extraction system of claim 36, wherein the ammonia reclamation system comprises:
a reaction tank in fluid connection with the gaseous eluent collection reservoir adapted to convert ammonia into ammonium salt solution;
an ammonium salt slurry/solution collection reservoir in fluid connection with the reaction tank;
a clarifier in fluid connection with the ammonium slurry/solution collection reservoir adapted to remove particulates; and
a concentrated ammonium reservoir in fluid connection with the clarifier adapted to receive purified ammonium salt solution.

42. A method of using seawater reject from desalination plants as a feed to produce fertilizer compositions using an ion exchange process.

43. The desalination method of claim 42, wherein the desalination method is based on reverse osmosis and the fertilizer composition is in a liquid form comprising at least potassium ions, ammonium ions, phosphorous ions or a combination thereof.

44. A method of using seawater reject from desalination plants as a feed to produce a liquid fertilizer formulation comprising at least one primary plant nutrient in combination with at least one secondary and/or micronutrients.

45. The method of claim 44, further comprising using the liquid fertilizer formulation to produce a solid fertilizer by crystallization, evaporation, precipitation, and any other solvent and solute separation techniques thereof.
